(19) United States
(12) Patent Application Publication
(10) Pub. No.: US 2014/0280241 A1
(43) Pub. Date: Sep. 18, 2014

(54) Methods and Systems to Organize Media Items According to Similarity

(71) Applicant: MediaGraph, LLC, Berkeley, CA (US)

(72) Inventors: Orion Reblitz-Richardson, Berkeley, CA (US); Alex Kerfoot, Oakland, CA (US); Michael Evans, Oakland, CA (US); Randall Breen, San Rafael, CA (US); Sina Jafarzadeh, San Francisco, CA (US); Ryan Shelby, San Leandro, CA (US); A. Peter Swearengen, San Francisco, CA (US); William Wright, Oakland, CA (US); Hunter Blanks, Oakland, CA (US); Michael Ludlam, San Anselmo, CA (US)

(73) Assignee: MediaGraph, LLC, Berkeley, CA (US)

(21) Appl. No.: 14/214,372

(22) Filed: Mar. 14, 2014

Related U.S. Application Data
(60) Provisional application No. 61/800,577, filed on Mar. 15, 2013.
(60) Provisional application No. 61/928,626, filed on Jan. 17, 2014.

(51) Int. Cl. G06F 17/30

(52) U.S. Cl. CPC G06F 17/3053
USPC 707/749

(57) ABSTRACT

Users collect digital media items such as songs, images, and videos into media libraries. Over time, the user can collect a very large number of media items making organization and use of the media library difficult and time-consuming. The systems and methods described herein alleviate this task by collecting metadata about the media items from multiple sources, determining a similarity between the media items, and clustering the media items with like media items. The systems and methods described herein can position the media items relative to one another in a layout based on their respective similarity. Feedback from the user and from other users can be added to the metadata and used to update the layout of the media items.

### PRIORITY

This non-provisional U.S. patent application claims priority to, and the benefit of, U.S. Provisional Patent Application No. 61/800,577 filed Mar. 15, 2013 and to U.S. Provisional Patent No. 61/928,626 filed Jan. 17, 2014, the entirety of each are hereby incorporated by reference herein.

### BACKGROUND

1. Field

This patent application is directed generally to data structures and data analysis and, more specifically to methods and systems to organize media items according to similarity.

2. Description of Related Art

Computer systems have been used to provide ways to display, or visualize, large amounts of data in a meaningful way. Computational data visualization is commonly used in academics, statistics, social and information sciences as tools and methods of illustrating interdependent, multidimensional relationships. As a general concept, automated visual distribution of content using algorithms to provide order based on content attributes such as content type, classification or similarity (information A.K.A. metadata) is not new. The visualizations are often based on customized algorithms to perform complex calculations on large data sets. For example, applications such as Gelphi (http://gephi.org/features/) have emerged to provide data visualization production tools using these methods.

Tools and algorithms applied to metadata (data about data) can produce visualizations which help demonstrate complex relationships (or differences) across multiple dimensions of information simultaneously. Most approaches utilize a physics model simulating springs, dampers, momentum and/or gravity to apply attraction to similar or repulsion from dissimilar content. Some approaches attempt to further illustrate relationships (connections A.K.A. edges) between content, representing prominence by modifying the size of text; enlarging more highly connected or diminishing more isolated content. An example can be found at http://drunksandlampposts.files.wordpress.com/2012/06/philprettyv4.png where the author has produced a network graph of philosophers using the Gelphi application. In the example, the author uses Wikipedia metadata (information about philosophers) referencing the influences each philosopher has had on every other listed. Relationships are represented as lines (an ‘edge’ in graph theory) which are displayed to illustrate each connection. The higher the number of connections, the larger the area (or more prominently) the respective philosopher is displayed. Similar techniques have been applied to consumer products such as Facebook apps which use an individual's metadata to create a visual distribution of their own social graph which groups (clusters) friends with shared connections (friends of friends).

In each of these examples, algorithms are used to bring similar content together, in effect grouping or clustering around similarity. Dissimilar content is moved away by displacement or repulsion as a byproduct of the force-based simulation. Typically these graphs are non-interactive, used for static demonstration purposes only. Interactive applications have also been produced such as the Visual Thesaurus which allows graph manipulation for entertainment purposes (http://www.visualthesaurus.com/app/view). Modifications made by these applications lack meaning, however, because editing is non-persistent and does not introduce changes to metadata.

With developments in modem data science, data visualization methods can be applied to facilitate the organization of very complex information sets, integrating many layers of information, allowing quick navigation and communication of meaning through association based on similarity. There is an opportunity to improve upon these techniques by incorporating interactive editing features to provide intuitive, modification with real-time effects on metadata otherwise very difficult to expose using conventional organizational methods.

### SUMMARY

An example method described herein comprises retrieving, by a computing system, over a network from a plurality of metadata providers, metadata about media items within a media library of a user, the metadata specifying one or more metadata types and one or more values of each of the specified one or more metadata types; creating, by the computing system, for each specified metadata type having one or more non-numerical values, a set of qualitative multi-valued tags by: accumulating the one or more non-numerical values; and calculating a normalized weight for each of the accumulated one or more non-numerical values; creating, by the computing system, for each specified metadata type having a single numerical value, a quantitative single-value tag by: calculating a tag weight based on the single numerical value relative to a predefined maximum numerical value; determining a similarity contribution of each specified metadata type between two of the media items in the media library by: combining, from each qualitative multi-valued tag of the two media items, the normalized weights of the accumulated one or more non-numerical values within each metadata type, and determining, from each quantitative single-value tag of the two media items, a difference between the respective tag weights of the quantitative single-value tags; calculating, by the computing system, a similarity score between each two of the media items from the similarity contribution of each metadata type, resulting in a set of similarity scores; and organizing, by the computing system, the media items into separate clusters based on the set of similarity scores.

An example system described herein comprises: a metadata module configured to retrieve, by a computing system, over a network from a plurality of metadata providers, metadata about media items within a media library of a user, the metadata specifying one or more metadata types and one or more values of each of the specified one or more metadata types; a tag module configured to create, by the computing system, for each specified metadata type having one or more non-numerical values, a set of qualitative multi-valued tags by: accumulating the one or more non-numerical values; and calculating a normalized weight for each of the accumulated one or more non-numerical values; the tag module further configured to create, by the computing system, for each specified metadata type having a single numerical value, a quantitative single-value tag by: calculating a tag weight based on the single numerical value relative to a predefined maximum numerical value; a similarity module configured to determine a similarity contribution of each specified metadata type between two of the media items in the media library by: combining, from each qualitative multi-valued tag of the two media items, the normalized weights of the accumulated one or more non-numerical values within each metadata type, and determining, from each quantitative single-value tag of the two media items, a difference between the respective tag weights of the quantitative single-value tags; the similarity module further configured to calculate, by the computing system, a similarity score between each two of the media items from the similarity contribution of each metadata type, resulting in a set of similarity scores; and a cluster module configured to organize, by the computing system, the media items into separate clusters based on the set of similarity scores.

An example non-transitory medium has instructions embodied thereon, the instructions are executable by one or more processors to perform operations comprising: retrieving, by a computing system, over a network from a plurality of metadata providers, metadata about media items within a media library of a user, the metadata specifying one or more metadata types and one or more values of each of the specified one or more metadata types; creating, by the computing system, for each specified metadata type having one or more non-numerical values, a set of qualitative multi-valued tags by: accumulating the one or more non-numerical values; and calculating a normalized weight for each of the accumulated one or more non-numerical values; creating, by the computing system, for each specified metadata type having a single numerical value, a quantitative single-value tag by: calculating a tag weight based on the single numerical value relative to a predefined maximum numerical value; determining a similarity contribution of each specified metadata type between two of the media items in the media library by: combining, from each qualitative multi-valued tag of the two media items, the normalized weights of the accumulated one or more non-numerical values within each metadata type, and determining, from each quantitative single-value tag of the two media items, a difference between the respective tag weights of the quantitative single-value tags; calculating, by the computing system, a similarity score between each two of the media items from the similarity contribution of each metadata type, resulting in a set of similarity scores; and organizing, by the computing system, the media items into separate clusters based on the set of similarity scores.

### BRIEF DESCRIPTION OF THE DRAWINGS

FIG. 1 is a diagram of an example environment in which various embodiments can be implemented.

FIG. 2 is a block diagram of a similarity system, according to an example embodiment.

FIG. 3 is a portion of a table containing metadata, according to an example embodiment.

FIG. 4 is a portion of a table containing tags created from the metadata, according to an example embodiment.

FIG. 5 is a portion of a table containing factor values for metadata types, according to an example embodiment.

FIG. 6 is a portion of a similarity matrix containing similarity scores, according to an example embodiment.

FIG. 7 is a portion of a dendrogram generated from the similarity matrix, according to an example embodiment.

FIG. 8 is a further portion of the dendrogram, according to an example embodiment.

FIG. 9 is an example of a hierarchical tree, according to an example embodiment.

FIG. 10 is an example of a modified hierarchical tree, according to an example embodiment.

FIG. 11 is an example relational layout, according to an example embodiment.

FIG. 12 is a further example relational layout, according to an example embodiment.

FIG. 13 is a further example relational layout and depicts a graphical user interface that can be used by a user to modify the relational layout, according to an example embodiment.

FIG. 14 is a portion of a table containing created tags, according to an example embodiment.

FIG. 15 is a portion of a table containing a user-altered tag, according to an example embodiment.

FIG. 16 is a flowchart depicting a method of organizing media items according to similarity, according to an example embodiment.

### DETAILED DESCRIPTION

A similarity system and method create an arrangement of media items, such as music, image, or movie files, from the user's own media library. The arrangement is distributed, grouped, and classified by similarity between the media items in the user's library. Determination of similarity and dissimilarity of media items is based on algorithms which weigh the relationships between media items, producing values that indicate the similarity of each media item with every other media item in the library. Display icons identifying the respective media items are positioned across the user's screen in an automated way based on relative similarity so that media items of a similar nature are placed closer together and dissimilar media items are spread further apart. The similarity system performs methods for repositioning of media items based on feedback received from the user to whom the media items belong. Changes made by users on their own collections are measured and factored into the core metadata used to organize media items in other users' libraries.

Similarity is determined by identifying relationships of each metadata type among the media items. Media items with high degrees of similarity are grouped into clusters. The similarity is further used to create cross-edges between the media items in the user's library. The cross-edges are used to arrange clusters of the media items relative to one another and to position the media items in a layout using a physics simulation. This system and method automates layout of users' media libraries to produce an individualized media map.

Information about the media library and data used to display that library (media items, positions, tree hierarchies, etc.) are stored in a database. In one embodiment, the user accesses this information through a website where a map of the media items in the user's media library is generated and displayed to the user. The user can edit the map by adding metadata about a media item or altering metadata about a media item. The changes (both by the user and by the system in response to the user) are stored in the database for subsequent display. Another embodiment is a tablet interface, with touch gestures that accesses and stores that same data (information about media items, positions, tree hierarchies, etc.) in the same user collection section of a database in the cloud.

An individual can change the organization of their own map by editing metadata (manipulate, reorder, and reconfigure) about data records in the user collection section. Editing features are provided to the user to allow repositioning of media items in the tree hierarchy or position on the map, effectively communicating a user's taste, preferences, and associations relative to other media elements. Information about changes made to the metadata is communicated back to the system which can then quantify how information across all users has been or should be changed. In this way, statistical measures of collective user modifications establish a feedback loop for the purpose of improving data quality (in prominence in the hierarchy and association between elements) over time.

FIG. 1 is a diagram of an example environment 100 in which various embodiments can be implemented. In the example environment 100, a similarity system 102 is configured to receive metadata via a network 104 (e.g., the Internet) from one or more metadata providers 106. The similarity system 102 is further configured to access one or more user libraries 108.

The similarity system 102 receives metadata from one or more metadata providers 106 via the network 104. The metadata providers 106 are external metadata providers known to those skilled in the art such as Discogs, MusicBrainz, Rovi, The Echo Nest, and Rotten Tomatoes. The metadata providers 106 include media providers (artists), publishers/distributors (record companies or movie producers), or metadata clearing houses such as Rovi or Wikipedia. Metadata received from the metadata providers 106 is referred to as “external metadata”.

The similarity system 102 is configured to establish a database indicating the media items included in the media library of the user (i.e., user library 108). The media items in the user library 108 (such as music or movie files) are identified from sources such as existing collections (music or movie library files), cloud-based network playlists, or select data accumulated directly by the user. Database entries, referred to as data records, are created for each song or video in the user's media library. In some instances, the media library may be a publically available list of media items, such as a “Top 500” list of songs published by a magazine. In other instances, a given user's media library may be a list of media items generated collaboratively by a group of individuals. Each data record is then populated with metadata from the metadata providers 106.

The similarity system 102 further receives additional metadata or alterations to the metadata of the media items from the user having the user library 108. The metadata received from the user is stored in connection with the user and referred to as “internal metadata”. The internal metadata provided by the user can affect the organization of the user's media library. In some instances, the internal metadata provided by other users for use in their media libraries 108 can be used to organize the user's media items in the user's library 108.

FIG. 2 is a block diagram of the similarity system 102, according to an example embodiment. The similarity system 102 comprises a metadata module 202, a user library module 204, a tag module 206, a similarity module 208, a cluster module 210, a database 212, a tree module 214, and a positioning module 216. The similarity system 102 can be implemented in a variety of ways known to those skilled in the art including, but not limited to, as a computing device having a processor with access to a memory capable of storing executable instructions for performing the functions of the described modules. The computing device can include one or more input and output components, including components for communicating with other computing devices via a network (e.g., the network 106) or other form of communication. The similarity system 102 comprises one or more modules embodied in computing logic or executable code such as software.

The metadata module 202 is configured to receive the external metadata from the metadata providers 106 and to receive the internal metadata via the user libraries 108. The metadata from the metadata providers is standardized by conforming each field to a structure with categorized (i.e., by type), multivalued, and weighted tags for each media item.

The structure of the metadata is based on dividing the metadata into one or more metadata types. The metadata types are generic attributes of the media items and can comprise, for example, Genre, Mood, Keywords, Decade, Year, Album, Artist, Actor, Director, Tempo, Danceability, and Energy. For each media item, one or more values are assigned to each metadata type.

Metadata types are logically divided into single-value types and multi-valued types. Single-value types are assigned one numerical value. Tempo is an example of a single-value type. Multi-valued types are assigned one or more values that are typically non-numerical. Examples of multi-valued types include title, artist, album, genre, and mood. To illustrate, while the song title “1999” is numerical and has only one value, the metadata type for the title is multi-valued because titles are typically non-numerical. The external metadata and internal metadata that is used to generate a map for the user (e.g., crowd-sourced metadata) is stored in the database 212.

The user library module 204 stores and retrieves the data records that identify the media items within the user's library 108. The user library module 204 can further store and retrieve the internal metadata that was provided by the user to whom the library belongs separately from the internal metadata provided by other users. When the internal metadata provided by the owner of the library is stored separately or is separately identifiable from metadata provided by the other users, it can be weighted more heavily than internal metadata provided by other users when determining similarity between the media items within the media library.

FIG. 3 is a portion of a table 300 stored in the database 212 containing metadata received by the metadata module 202 and the user library module 204 according to an example embodiment. As discussed above, for tag creation, the similarity system 102 receives data from internal (user-added) and external (MusicBrainz, The Echo Nest, Rovi, etc.) sources and normalizes the metadata into a pre-defined structure. Table 300 includes metadata gathered from three external metadata providers (“Provider 1”, “Provider 2”, “Provider 3”) plus metadata added by one or more users (“User-Added”). Note that this metadata is an example and is not actual metadata extracted from providers. The example uses five different metadata types (“Album”, “Artist”, “Genre”, “Mood”, and “Tempo”), but the number of metadata values within each metadata type and the total number of metadata types are not limited to the embodiment shown.

The metadata gathered from the one or more different users and metadata providers 106 depicted in table 300 is combined to create a normalized set of tags and prominence scores by the tag module 206 of FIG. 2. Because each user can provide their own metadata to supplement the metadata received from the metadata providers 106, the tag module 206 is configured to create a set of tags for each user library 108. The tag module 206 is configured to create the normalized set of tags for each metadata type, including single-value types and multi-value types.

To create a qualitative tag (a tag indicating some quality of or about a media item) from a multi-value metadata type, the tag module 206 accumulates the one or more non-numerical values included in the metadata and calculates a normalized weight for each of the accumulated one or more non-numerical values. The normalized weights can be expressed as percentages that add up to 100%. FIG. 4 is a portion of a table 400 containing tags created from the metadata of table 300, according to an example embodiment.

For example, to create qualitative tags for the song “Don't Stop Till You Get Enough”, the tag module 206 retrieves the data listed in that song's row in table 300. The tag module 206 assigns an artist tag of “Michael Jackson” weighted at 100% since he is the exclusive primary artist included in the metadata. The album tag, “Off the Wall” is weighted at 100% because it is the only album and is calculated in the same fashion.

In the case of genre, more than one value is included in the multi-value metadata for this song. “R&B” is gathered from both “Provider 1” and “Provider 3” (“Provider 2” having provided no such data), while “Urban” and “Pop” were added by one or more users. In some instances, the tag module 206 considers the internal and external metadata to be of equal influence, so “Urban” and “Pop” both receive a weight of 25%, while “R&B” receives a weight of 50%, twice the others. For mood tags, “Provider 3” provided the relative weights, so “Fiery” is weighted at 50%, “Slick” is weighted at 25% and “Confident” is also 25%. If a user manually added mood tags, they would also be included and be evenly weighted (50% each for 2 tags, 33% each for 3 tags, etc.) before being combined with the weights received from “Provider 3”. Various other normalization techniques that can be used to calculate these weights are known to those skilled in the art.

To create a quantitative tag (a tag indicating some quantity of or about the media item) from a single-value metadata type, the tag module 206 selects a tag name from a predefined set of tag names available for the metadata type and then calculates a tag weight based on the single numerical value relative to a predefined maximum numerical value for the metadata type.

For example, to calculate the tempo tag for “Don't Stop Till You Get Enough”, the tag module 206 retrieves the tempo value returned from “Provider 2” in that song's row in the table 300 (row 3). In one embodiment, the set of tempo tags has three possible pre-defined tag names: “Down Tempo”, “Mid Tempo”, and “Up Tempo”. A media item can only have one tempo tag. For example, a song cannot be both up- and down-tempo.

Unlike the multi-valued tags discussed elsewhere herein, the tag weight for tempo need not total 100%, which allows the tag module 206 to calculate a tag weight that indicates how much up-, down-, or mid-tempo a song is. Assuming that a tempo cannot be above a pre-defined maximum value of 500 beats per minute, an example formula used to determine the tag name (TAG_NAME) and tag weight (TAG_WEIGHT) from the tempo value (TEMPO) and max tempo (MAX_TEMPO) is:

MAX_TEMPO = 500 BPM
TEMPO = TEMPO / MAX_TEMPO
IF TEMPO > 0.75:

TAG_NAME = “Up Tempo”
TAG_WEIGHT = TEMPO

ELSE IF TEMPO < 0.25:

TAG_NAME = “Down Tempo”
TAG_WEIGHT = 1 − TEMPO

ELSE:

TAG_NAME = ‘Mid Tempo’
TAG_WEIGHT = TEMPO

Using this formula, in the case of “Don't Stop Till You Get Enough”, the tempo retrieved from the table 300 is 119 BPM and the tag module 206 generates a “Down Tempo” tag with weight 76% (because 119/500 is 0.238 which is less than 0.25). For “It's A New Day”, the tempo tag is also “Down Tempo”, but with a weight of 77%.

The tag module 206 is further configured to calculate a prominence score for the media item that is used by the tree module 214 as explained elsewhere herein. The prominence score is a numerical value that correlates to the popularity and prominence of a given media item. To illustrate, to calculate the prominence score for the song “Don't Stop Till You Get Enough”, the tag module 206 retrieves scores from the metadata providers 106 and the users. The tag module 206 can additionally use data such as play counts and other user inputs (for example, skip count, how recent the play was, etc.) to calculate the prominence score of the media item. In this case, the score from “Provider 3” is 9 and the user score is 9. These sources can be weighted equally or skewed more heavily towards the user or metadata provider. The range of both scores is 0-10 with 10 being the best and 0 the worst. An example formula used to calculate the prominence score is:

PROMINENCE_SCORE=(PROVIDER_SCORE+USER_SCORE)/20

Where the denominator “20” is the sum of the maximum provider score (10) and the maximum user score (10). For the song “Don't Stop Till You Get Enough”, a prominence score of 90% is calculated, which ranges from 0-1 with 1 being best. Using the same technique, for the song “It's a New Day”, the prominence score is calculated as 70%.

The similarity module 208 is configured to determine a similarity score between each two media items in the user's media library based on the qualitative, multi-value tags and the quantitative, single-value tags. For each metadata type, a similarity contribution is determined that indicates an amount of similarity between two media items. To calculate the similarity contribution for each metadata type, a modified version of a pair-wise distance (pdist) algorithm is used. Pdist algorithms are available in a wide variety of libraries used by those in the art including SciPy, MATLAB, and others. In an embodiment, the pdist algorithm is modified to take into account single-valued as well as multi-valued tags.

The pdist algorithm is further modified to calculate similarity rather than distance. Similarity is the reverse (or inverse) of distance. Similarities range from 0 to 1.0, with zero indicating not similar at all and 1.0 indicating perfectly similar. Distance is the opposite, with most similar having zero distance and least similar having a large distance.

The pdist algorithm is still further modified to calculate similarity contributions for both single-valued and multi-valued tags. To calculate the similarity contribution, single-valued tags are converted from percentages into numeric values of their weights. The numeric values are not the same as the numerical values included in the metadata. The difference between the numeric values is determined via subtraction. To calculate the similarity contribution, multi-valued tags are compared by combining the normalized weights between shared tag values.

The single-valued contribution to similarity (SIM_CONTRIB) between media item M1 and media item M2 from tags M1_SV_TAG and M2_SV_TAG (e.g., tempo tags) is

VAL1 = M1_SV_TAG.weight
VAL2 = M2_SV_TAG.weight
SIM_CONTRIB = 1 − ABS(VAL1 − VAL2)
RETURN SIM_CONTRIB

The multivalued contribution to similarity (SIM_CONTRIB) between media item M1 and media item M2 from two sets of multivalued tags M1_MV_TAGS and M2_MV_TAGS is

SIM_NUMERATOR = 0
SIM_DENOMINATOR = 0
FOR TAG IN M1_MV_TAGS:

FOR TAG2 in M2_MY_TAGS:

IF TAG.name == TAG2.name:

SIM_NUMERATOR += TAG.weight + TAG2.weight

SIM_DENOMINATOR += TAG2.weight

SIM_DENOMINATOR += TAG.weight

SIM_CONTRIB = SIM_NUMERATOR / SIM_DENOMINATOR
RETURN SIM_CONTRIB

The similarity contributions are combined into a single similarity score between M1 and M2. Tags created from other metadata types can be included in the similarity calculation when available. In this example, the similarity contributions were calculated from the created tags from artist, album, genre, mode, and tempo, so the similarity SIM between M1 and M2, given factors (*_FACTOR) and contributions of similarity (*_SIM) is:

$$SIM = \frac{( \begin{matrix}ARTIST\_FACTOR * ARTIST\_SIM + \\ ALBUM\_FACTOR * ALBUM\_SIM + \\ GENRE\_FACTOR * GENRE\_SIM \_ + \\ MOOD\_FACTOR * MOOD\_SIM + \\ TEMPO\_FACTOR * TEMPO\_SIM\end{matrix} )}{( \begin{matrix}ARTIST\_FACTOR + ALBUM\_FACTOR + \\ GENRE\_FACTOR + MOOD\_FACTOR + \\ TEMPO\_FACTOR\end{matrix} )}$$

where factors are pre-defined according to metadata type. FIG. 5 is a portion of a table 500 containing factor values for metadata types, according to an example embodiment. The factors listed in table 500 to combine contributions from tags are tunable. For example, if the user wants to see media items clustered by genre, the GENRE_FACTOR is increased. If a user wants to see media items clustered by tempo, the TEMPO_FACTOR is increased. These values are tuned by the user selecting presets and by minor adjustments to those factors when users provide additional metadata.

The output of the similarity module 208 on all media in the user's library 108 is a set of pair-wise similarities between all the media items ranging from 0 to 1.0. FIG. 6 is a portion of a triangular similarity matrix 600 containing a set of similarity scores, according to an example embodiment.

To illustrate the calculations for the similarity contribution and similarity calculation, the songs “Sign O' The Times” and “Don't Stop Till You Get Enough” are compared in the following example. First, the similarity module 208 accumulates all of the tags in table 400 for each metadata type for the two songs. For “Sign ‘O’ The Times,” the tags are: Artist: “Prince” (100%), Album: “Sign ‘O’ The Times” (100%), Genre: [“R&B” (50%), “Urban” (25%), “Neo-Psychedelia” (25%)], Mood: [“Paranoid” (50%), “Eccentric” (25%), “Tense” (25%)], Tempo: “Down Tempo” (80%). For “Don't Stop Till You Get Enough,” the tags are: Artist: “Michael Jackson” (100%), Album: “Off the Wall” (100%), Genre: [“R&B” (50%), “Urban” (25%), “Pop” (25%)], Mood: [“Fiery” (50%), “Slick” (25%), “Confident” (25%)], Tempo: “Down Tempo” (76%).

Next, the similarity contribution of each metadata type is determined. To illustrate, the qualitative, multi-value tags for the metadata type “genre” for the two songs being compared are: [“R&B” (50%), “Urban” (25%), “Neo-Psychedelia” (25%)] and [“R&B” (50%), “Urban” (25%), “Pop” (25%)]. The two songs both have the tags “R&B” and “Urban”. The total shared weight (SIM_NUMERATOR) is 50%+25% from “Sign ‘O’ The Times” plus 50%+25% from “Don't Stop Till You Get Enough”, for a total of 150% (or 1.5). The total weight across all genre tags (SIM_DENOMINATOR) is 50%+25%+25%+50%+25%+25%, for a total of 200% (or 2.0). The GENRE_SIM is then 1.5/2 or 0.75.

To illustrate the similarity contribution for a quantitative, single-value metadata type “tempo” for the two songs being compared are: “Down Tempo” (80%) with “Down Tempo” (76%). These are converted to a numeric value by looking at the tag name and weight. They are both “Down Tempo”, so values are 1−weight. The TEMPO_SIM is then 1−ABS((1−0.8)−(1−0.76))=0.96.

The similarity module 208 combines the similarity contributions from each metadata type to calculate a total similarity score between “Sign ‘O’ The Times” and “Don't Stop Till You Get Enough”. In this example, the similarity contributions are weighted with the type values in table 500. Because there is no overlap between artist, album, and mood and some overlap between genre and tempo, the similarity contributions (calculated as detailed above) are: ARTIST_SIM=0, ALBUM_SIM=0, GENRE_SIM=0.75, MOOD_SIM=0, and TEMPO_SIM=0.96. The similarity (SIM) is calculated as: SIM=(5*0+5*0+2*0.75+1*0+1*0.96)/(5+5+2+1+1)=2.46/14=0.176=17.6%.

The cluster module 210 is configured to organize the media items in the user's media library into clusters. In some embodiments, the cluster module 210 uses a standard (as known in the art) hierarchical agglomerative clustering (HAC) algorithm plus a customized flat clustering algorithm to segment the media items in a user library 108 into separate clusters.

To use the HAC algorithm, the cluster module 210 converts the triangular similarity matrix 600 into a triangular distance matrix. A similarity of zero converts to a distance of 1.0, while a similarity of 1.0 converts to a distance of zero. There are many functions for performing this operation known to those skilled in the art including those at http://stackoverflow.com/questions/4064630/how-do-i-convert. One such function that can be used by the cluster module 210 is:

DIST=1−SIM

The cluster module 210 feeds the distance matrix into the HAC algorithm and the output is a dendrogram data structure specifying how media items are “agglomerated” up to a single cluster. The HAC algorithm starts with each media element being in its own cluster. Each step in the agglomeration combines the two most-similar existing clusters into a new cluster and recalculates the similarity of the new cluster to all other clusters. The calculation of this new cluster similarity is tunable. The cluster module 210 uses the average weighted by cluster size.

The cluster module 210 feeds the output data of the HAC algorithm into a custom flat clustering algorithm that “cuts” the single cluster into more than one cluster. The custom flat clustering algorithm is based on a method known in the art and provided in SciPy (http://docs.scipy.org/doc/scipy/reference/cluster.hierarchy.html). Unlike the SciPy method, the custom flat clustering algorithm considers a pre-defined maximum distance (minimum similarity) above which media is forced into separate clusters and a pre-defined minimum distance (maximum similarity) at which media is required to be clustered together. The cluster module 210 iterates through the dendrogram top to bottom and determines where distance falls within these constraints and cuts the dendrogram into clusters at that position. The output is a set of clusters that are subtrees within the dendrogram.

FIG. 7 is a portion of a dendrogram 700 generated from the similarity matrix, according to an example embodiment. The cluster module 210 cuts the dendrogram 700 to create clusters (e.g., at point A) and, in particular, this section creates the “Urban” cluster with fourteen songs because of their relative high similarity to each other in comparison to other media items. FIG. 8 is a further portion 800 of the dendrogram 700, according to an example embodiment, that depicts the cluster at point A. The cut for this cluster happens at the left-hand of the image, right above “Jam” at point A. The cluster is made as described with a maximum distance of 0.99, which translates to a minimum similarity of 1%, and a minimum distance of 0.01, which translates to a maximum similarity of 99%. These songs have a similarity greater than 1% and therefore are clustered.

The tree module 214 is configured to construct a hierarchical tree structure (see, e.g., http://en.Wikipedia.org/wiki/Tree_(data_structure)) for each of these clusters. The tree module 214 breaks the media items in the cluster into three groups: Parent, Children, and Children's Children. The tree module 214 further subdivides the tree to establish a desired distribution of nodes.

Once the cluster is established, a parent is identified by determining the most prominent representative for the group based on the prominence score calculated by the tag module 206. Edges in this tree are directional, representing the parent-child relationship for each media item within the library. Once identified, the parent for the cluster is referred to as P0. The similarity matrix is used to establish a gross sub-clustering of mid-level children (C1) and lower level children's children (C2) by looking for similar or dissimilar media. Dissimilar media items are assigned as C1 under P0, similar media items are assigned as C2 under both P0 and C1 in the tree. Unconventionally, C2 children under P0 parents can be represented at the same level of the tree as other C2 children under C1 parents.

The prominence level of the root node (P0) is calculated based on the cluster/tree size by the tree module 214 using the following logic: Large Tree (e.g., greater than ten items): Root (P0) is set to the prominence level L0. Medium Tree (e.g., greater than four items): Root (P0) is set to the prominence level L1. Small Tree (e.g., equal to or less than four items): Root (P0) is set to the prominence level L2.

Given the root prominence level, PROM_LEVEL(P0), first-level children (C1) are assigned a prominence level of PROM_LEVEL(P0)+1 and all others are assigned a prominence level of PROM_LEVEL(P0)+2. To determine which media items are C1 and which are C2 plus which media item they are parented to in the tree, the tree module 214 iterates through all other items in the cluster, comparing them to potential parent candidates using a similarity threshold (SIM_THRESHOLD), which combines very similar items in the same sub-cluster. Adjusting the similarity threshold (or cut-off) value determines the number of children at a given level. The similarity threshold value can be changed to increase/decrease the number of children's children (C1 or C2) and used to enforce the clustering of very similar media (such as songs on the same album).

To do this, the tree module 214 iterates through each media item in a cluster that is not the root. For each, the parent is determined by looking at the similarity between it and the root (P0), followed by a comparison with any first-level children (C0). The most similar parent candidate is compared to the similarity threshold (SIM_THRESHOLD) and, if exceeded, the media item is parented under P0 or a C1. This means media items with high similarity are grouped under a P0 or a C1 parent. Media items that are dissimilar are added to the root as a second-level parent (C1).

As described above, the tree module 214 generates a rough tree structure by determining the P00 root, C1 children, and C2 children. To start, the dendrogram 700 is cut, isolating a cluster of 14 media items (e.g., Cluster A of FIG. 8). The prominence score of each media item in the cluster are compared (retrieved, e.g., from the similarity matrix 600). In the case of a tie, the earliest media item (the one added first to the user's collection) is selected. Because the cluster has 14 items it is determined to be a ‘Large Tree’, and as a result the root (P0) will be mapped to L0 prominence level.

FIG. 9 is an example of a hierarchical tree 900, according to an example embodiment. The media item “Don't Stop Til You get Enough” has the highest prominence score (90%) and becomes the representative (root or P0) for the cluster. The children (C1) are “Sign ‘O’ The Times”, “Control”, “Theme From Shaft”, “Lost Ones, “Movin On”, “It's A New Day”, “1999”, “I Stand Accused”, and “Introduction by Fats Gonder”. The second-level children (C2) have similarity greater than SIM_THRESHOLD with the parent (P0) or one of the children (C1s) producing three C2s to be set to L2 prominence. As shown in FIG. 9, the second-level children are “Let's Go Crazy” (under “Sign ‘O The Times”), “Rhythm Nation (under “Control”), “Jam” and “Wanna Be Starting Something” (under “Don't Stop Till You Get Enough”). As a note, “Jam” and “Wanna Be Starting Something” have similarity with the root (P0) and therefore are located two levels below (under a pseudo-node) as a result.

The dendrogram 700 illustrates the relationship between remaining media elements within the cluster with each other and P0. To determine first-level children (C1) and second-level children (C2) and their parentage, the similarity matrix 600 is accessed. For each media item, the tree module 214 finds the most similar item from the set of P0 and any existing C1 children. If the similarity threshold (SIM_THRESHOLD, set to 70%) is passed, the media item is set as a C2 parented from the set of P0 or any of the existing C1 children. Otherwise, it is set as a C1, parented to P0 and added to the list of C1 as a potential parent for future media items. The first-level children (C1) are identified by lack of similarity with P0 and other C1s, producing nine children to be set to L1 prominence.

The initial calculation of hierarchical tree structures can produce poor visual results when some children produce siblings many levels deep, while others can be empty. To address this issue, a specific visual layout density is targeted by the tree module 214. The targets are based on user studies, academic research, and models such as the golden ratio and golden spiral.

Based on the targets and prior to media map creation, the first order tree structure (P0, C1, C2) is further modified by the tree module 214 to achieve a target visual density by expanding the tree structure to achieve the target visual density. Areas of the graph with too many media items to display effectively are pushed down the tree. The process of achieving the target visual density uses a combination of factors to establish the tree depth and as a result the relative prominence of each media element. The prominence level will determine the size (and area) the media item represents on the map. Media items at the top of the tree (P0) will be displayed at the highest prominence with child nodes (C1, C2) as lower prominence below throughout the tree representing progressively less significant media within the cluster.

The first order tree structure (P0, C1, C2) is first subdivided (as necessary) to optimize the depth of the tree to achieve a normalized distribution of media at each level of the tree structure. To achieve this, Parent/Child assignments are converted to levels of prominence, the number of which is determined by the media items in the cluster. Prominence levels start at L0 for the most prominent items and increase to L6 and beyond for the least prominent. In large trees, P0 will be represented by L0 (most prominent), C1 will be subdivided into L1, 2, 3, etc and C2 will be subdivided into L4, 5, 6, etc. In small trees, no subdivision is necessary in which case only three levels of depth are required. It may be desirable to represent smaller trees as less prominent in the overall presentation of the map in which case the system allows P0 to be mapped to lower levels of prominence such as L2 to designate less visual area with the associated material. In this case, C1 would then map to L3 and C2 would map to L4.

The process used to achieve the target visual density is referred to as ‘tree fan-out,’ which modifies the distribution at a given level of prominence to limit groups of children to no less than two and no more than seven. Tree fan-out adjusts the gross hierarchical tree structure and consequently the prominence levels calculated to accommodate this goal.

A tree fan-out algorithm converts the hierarchical trees into simpler “pseudo-node” tree structures. In these structures, the prominence level of a given node is directly defined by its level within the hierarchy and each internal (non-leaf) node containing children of more than one prominence level away contains a “pseudo-node” child that is itself represented at a lower level of prominence. This then contains the lower-level prominence children.

Starting at the root, the tree fan-out algorithm traverses each “pseudo-node” tree in a breadth-wise fashion, adjusting parents and prominence levels to meet the above goal. If the minimum fan-out is not achieved, the tree module 214 pulls children up the tree and increases their prominence. If the maximum fan-out is exceeded, the tree module 214 pushes nodes down the tree or moves them to a sibling. In general, the tree module 214 keeps more similar media items closer to a given parent and pushes less similar media items further from the parent.

The tree fan-out algorithm operates as follows. For a given pseudo-node tree T with root R, the tree module 214 iterates through the pseudo-node tree T breadth-wise, starting with R as N. For each level of the tree (and prominence level) the tree module 214 iterates over the nodes. For each node (N) of prominence P=PROM_LEVEL(N), the system checks the number of children (C_COUNT). If C_COUNT is less than MIN_FANOUT (a tunable constant set to, for example, 2), the tree module 214 looks at direct children of N that are at a lower prominence level and, if they exist, those items have their prominence increased to P+1. If more children are needed, the tree module 214 looks at grandchildren (children of children). If the grandchildren exist, those items are made a child of N and have their prominence increased to P.

If C_COUNT is greater than MAX_FANOUT (a tunable constant set to, for example, 7), the tree module 214 sorts the children of N (C_LIST) by their similarity to N. The tree module 214 looks for a non-full ancestor (parent or parent of parent) A to pull children to. If it exists, the least similar child C of N is pulled and made a child of A. The prominence of C is changed to PROM_LEVEL(A)+1. The tree module 214 then looks for a non-full sibling B to pull children to. If it exists, the least similar child C of N is pulled and made a child of B. Prominence of C is changed to PROM_LEVEL(B)+1. Lastly, if C_COUNT still exceeds MAX_FANOUT, the most similar child C of N is pushed down and made a child of another child C2. This child C2 might be N itself as a pseudo-node. The tree module 214 repeats this algorithm until both min and max fan-out are satisfied for all nodes.

FIG. 10 is an example of a modified hierarchical tree 1000, according to an example embodiment. As an example, the tree module 214 generates the rough pseudo-node tree structure shown in FIG. 9 for the cluster of fourteen media items shown in the dendrogram 700. The tree fan-out algorithm is run to enforce a minimum and maximum number of items at each level. The tree module 214 iterates through the tree under “Don't Stop Til You Get Enough”. For “Don't Stop Til You Get Enough”, the number of children (C_COUNT) at L1 exceeds the pre-defined MAX_FANOUT of 7. “Theme from Shaft” is the most similar to “I Stand Accused” and so is parented to the same. Its prominence was also changed to L2. The number of children (C_COUNT) at L1 still exceeds the MAX_FANOUT of 7. “Introduction by Fats Gonder” is the most similar to, and is parented to, “It's A New Day”. Its prominence was also changed to L2. This process ultimately generates the tree structure 1000.

The positioning module 216 positions the organized media items relative to one another for display to the user. As has been described, a representational tree structure forces media items to be in one region (or cluster) on the map. Media items are then positioned under their parent and, in a voronoi representation discussed below, in the parent cell. Even though the cluster in which the media items are positioned is fixed, media items are “pulled” towards similar media items on the map, even if those similar media items are not within the same cluster. To achieve this, the positioning module 216 creates cross-edges outside (and in addition to) the tree structures and uses them to pull similar media items together. Cross-edges are generated for pairs of media items with non-zero similarity and can be within or across trees (and clusters). The amount of force the cross-edges exert on the media items is directly proportional to the similarity between the two media items.

While a different number of cross-edges can be generated, in an embodiment, the positioning module 216 generates the top twenty cross-edges from each media item. This way, the positioning module 216 represents the similarity values in the force layout while managing performance.

FIG. 11 is an example relational layout 1100, according to an example embodiment. In this example, the positioning module 216 creates a cross-edge between two songs from two different hierarchical tree structures. In FIG. 11, while the similarity between “Don't Stop ‘Til You Get Enough” by Michael Jackson and “One More Time” by Daft Punk is not high enough to combine into one hierarchical tree (cluster) structure, their similarity is high enough to be within the top twenty most similar songs on the map for “Don't Stop ‘Til You Get Enough” and therefore a cross-edge 1102 is generated. The cross-edges supply spring-like forces that pull similar media together. More similarity means a stronger force is applied.

The positioning module 216 uses a physics-based force layout (see, e.g., http://en.Wikipedia.org/wiki/Force-directed_graph_drawing) to position the clustered media items in the user's library and clusters relative to each other. The tree structure, cross-edges, and, optionally, voronoi structure (described below) all play a part. The forces from cross-edges and voronoi structure are applied with inertia and decay over time, which means the layout stabilizes. This is done using Verlet integration (http://en.Wikipedia.org/wiki/Verlet_integration), which is a method known to those in the art. When movement drops below a threshold, the force layout is stopped until additional or altered metadata is received.

The voronoi cells affect layout in two ways. The voronoi cells can either contain media or remain empty. To adjust layout, first, each item is moved towards the center (or centroid) of its parent voronoi cell. This process is called Lloyd relaxation (see, e.g., http://en.Wikipedia.org/wiki/Lloyd's_algorithm). Second, for those cells containing media, the position of media items within a parent cell are “clipped” or constrained to always be within the parent cell. This means that even a very strong cross-edge force from outside the cell will not move a media item out of its representative parent cell.

The voronoi influence on layout is optional. An alternative is to not use voronoi cells and exclusively use the tree structure and cross-edges. In this alternative, parent edges in the tree structure act like cross-edges. Also, a repulsive force between siblings in the tree structure is added in place of the Lloyd relaxation described above. For other visual representations (tree maps, pure graphs, etc.) the system can rely on the exclusive use of tree structure and cross-edges.

FIG. 12 is a further example relational layout 1200, according to an example embodiment. Based on the similarity given in the example, similar clusters of media items are positioned close to each other, while dissimilar clusters are positioned far apart. In FIG. 12, the clusters “Urban” and “House” are close to each other because of the similarity of the media items within the clusters, causing an attractive force to be applied. Some of those similarities are listed in similarity matrix 600. On the other hand, the clusters “Indie Rock” and “Urban” are apart because the media items in those clusters have little similarity, causing a repulsive force to be applied.

FIG. 13 is a further example relational layout 1300 and depicts a graphical user interface that can be used by a user to modify the relational layout 1300, according to an example embodiment. Upon generating the relational layout as depicted in FIG. 12, the user can change this structure and those changes are fed back into the similarity system 102 and are reflected in calculated similarity scores. The user can change this structure by adding metadata, deleting metadata, or altering metadata for one or more media items, specifying the characteristics of the song in more detail. He can also move media items and position media items that he considers similar closer together.

For example, a user adds the metadata “Indie Rock” to the song “Losing My Religion” by “R.E.M.” through a graphical user interface with auto-complete as depicted in FIG. 13. The auto-complete functionality can suggest metadata that are associated with other media items.

FIG. 14 is a portion of a table 1400 containing created tags, according to an example embodiment. As an example, in table 1400, the similarity score between “Losing My Religion” and two other songs based on metadata from different metadata types (Artist, Genre, Mood) is shown. In this example, each metadata value in a metadata type has the same weight. The songs “Losing My Religion” and “Country Feedback” have the following metadata: Artist: “R.E.M” (Similarity in that category 1.0), Genre: Rock, College Rock (Similarity in that category 1.0), Mood: Reflective (Similarity in that category 0.5). This results in the similarity score of 0.83 as described in the detailed description of the similarity score. The songs “Losing My Religion” and “Waiting for the World to Change” by “John Mayer” have the following metadata in different metadata types: Genre: Rock (Similarity in that category 0.5), Mood: Reflective, Intimate (Similarity in that category 1.0). This results in the similarity score of 0.5.

FIG. 15 is a portion of a table 1500 containing user-altered metadata, according to an example embodiment. As shown in table 500, the introduction of the “Indie Rock” metadata value to the song “Losing My Religion”, changes the similarity to other songs based on the metadata matches. In this example, each metadata type has the same type value. The songs “Losing My Religion” and “Country Feedback” share the following metadata values in the metadata types: Artist: R.E.M (Similarity in that category 1.0), Genre: Rock, College Rock (Similarity in that category 0.83), Mood: Reflective (Similarity in that category 0.5). This results in the similarity of 0.77 as described in the detailed description of the similarity score. The songs “Losing My Religion” and “Waiting for the World to Change” by “John Mayer” share the following tags in the different categories: Genre: Rock, Indie Rock (Similarity in that category 0.83), Mood: Reflective, Intimate (Similarity in that category 1.0). This results in the similarity of 0.61). When a user alters the metadata associated with a media item, edges connecting that media item to other media items on the map are updated so the new position of the media item in the map reflects the new similarity scores.

In some instances, a user can drag media items closer together or further apart within the map displayed as part of a graphical user interface. The similarity scores between the dragged media item and the other media items are updated based on the new position of dragged media item using a calculation that compares the original length of an edge (distance between media items, including the dragged media item) to the new length of the edge. Given original distance (OLD_DIST), new distance (DIST), and old similarity score (OLD_SIM), the new similarity score SIM is calculated as follows:

SIM=OLD_SIM*(OLD_DIST/DIST)

The new similarity score is calculated for all edges connected to moved media and the change in similarity score is recorded and saved to the server. The similarity score change impacts force layout immediately, since edges with decreased weight apply a reduced force and edges with increased weight apply a higher force. The changes also impact the future clustering and weights as detailed below.

The changes that a user makes to the position of the media items and structure via the graphical user interface affect the importance of specific tag types (for example “Genre” vs “Mood”) globally and locally on the user's map. For example, if a lot of clusters are being created around “Mood” (e.g., “Tense”, “Lively”, “Playful” area labels being generated) then the system infers that this is more important to the user than “Genre” and increases MOOD_FACTOR and decreases GENRE_FACTOR as listed in table 1500. These adjustments on the factor values have an impact when a new media item is brought into the map and when sections of the map are reclustered.

In one embodiment, the movement of media items via the graphical user interface into a cluster further assigns new metadata to the moved media item. For example, a user moves a media item into a cluster with the “Tense” label. The similarity system 102 then adds “Tense” to the “Mood” metadata about the media item. The weight of the added metadata value is calculated by looking at the area label weight (essentially the average weight of the metadata value within the cluster, as calculated above) and taking the maximum of that weight and the weight of the metadata value, if it exists. In an example, the calculation for moved media M and new parent P is as follows:

LABEL = AREA_LABEL(P, PROM LEVEL(M) − 1
LABEL_WEIGHT = TAG_WEIGHT(LABEL)
// Get the existing tag on M with type and name of LABEL
EXISTING TAG = TAG(M,

TAG_TYPE(LABEL),
TAG_NAME(LABEL))

EXISTING_TAG_WEIGHT = 0
IF EXISTING_TAG:

EXISTING_TAG_WEIGHT = TAG_WEIGHT(EXISTING_TAG)

ELSE:

// Create tag with type and name of LABEL plus
// weight 0
EXISTING_TAG = NEW_TAG(TAG_TYPE(LABEL),

TAG_NAME(LABEL),
EXISTING_TAG_WEIGHT)

TAG_WEIGHT(EXISTING_TAG) = MAX(LABEL_WEIGHT,

EXISTING_TAG_WEIGHT)

The automatic modification of cross-edges connecting the media items by the similarity system 102 creates a feedback loop where the user can affect the positioning calculations used for their media library and even factor values used when new media items are added to their media library.

FIG. 16 is a flowchart depicting a method 1600 of organizing media items in a user's media library according to similarity, according to an example embodiment. The method 1600 can be performed by, for example, the similarity system 102.

In an operation 1602, metadata about media items within a user's media library is retrieved by, for example, the metadata module 202 as described above. External metadata is retrieved from one or more metadata providers 106. In some instances, internal metadata received from the user who owns the media library is retrieved. In further embodiments, internal metadata received from other users about the media items in the user's media library is retrieved.

In an operation 1604, tags are created for each media item from the retrieved metadata by, for example, the tag module 206 as described above. The created tags include qualitative multi-valued tags and quantitative single-value tags.

In an operation 1606, a similarity score indicative of the similarity between each two media items in the user's media library is calculated from the created tags. The similarity score can be calculated by, for example, the similarity module 208 as described above. The similarity scores are organized into a set of similarity scores.

In an operation 1608, the media items in the user's media library are organized into clusters by, for example, the cluster module 210 as described above.

In an operation 1610, the media items within each of the clusters are organized into a hierarchical tree by, for example, the tree module 214.

In an operation 1612, the media items are positioned in a layout based on cross-edges between media items that are not in the same cluster by, for example, the positioning module 216.

In an operation 1614, additional or altered metadata about one or more of the media items in the user's library can be received from the user to whom the media library belongs by, for example, the user library module 204. If metadata is received from the user, the method 1600 returns to operation 1604. In some instances, the method 1600 optionally returns to operation 1602.

In an operation 1616, additional or altered metadata about one or more of the media items in the user's library can be received from other users of the similarity system 102 by, for example, the user library module 204. If metadata is received from another user, the method 1600 returns to operation 1604. In some instances, or if no metadata is received, the method 1600 optionally returns to operation 1602.

The system and methods described herein allow a user to organize media items in the user's media library. Metadata about the media items is retrieved from both internal and external sources. Qualitative and quantitative tags are created from the metadata, and similarity scores between pairs of media items with the media library of the user are calculated. The media items are clustered and organized into hierarchical trees within each cluster. Using cross-edges calculated from the similarity scores, the media items are positioned in a layout relative to one another. User feedback and feedback received from other users can be used to modify the metadata and re-generate the tags, resulting in an updated layout.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
retrieving, by a computing system, over a network from a plurality of metadata providers, metadata about media items within a media library of a user, the metadata specifying one or more metadata types and one or more values of each of the specified one or more metadata types;
creating, by the computing system, for each specified metadata type having one or more non-numerical values, a set of qualitative multi-valued tags by:
accumulating the one or more non-numerical values; and
calculating a normalized weight for each of the accumulated one or more non-numerical values;
creating, by the computing system, for each specified metadata type having a single numerical value, a quantitative single-value tag by:
calculating a tag weight based on the single numerical value relative to a predefined maximum numerical value;
determining a similarity contribution of each specified metadata type between two of the media items in the media library by:
combining, from each qualitative multi-valued tag of the two media items, the normalized weights of the accumulated one or more non-numerical values within each metadata type, and
determining, from each quantitative single-value tag of the two media items, a difference between the respective tag weights of the quantitative single-value tags;
calculating, by the computing system, a similarity score between each two of the media items from the similarity contribution of each metadata type, resulting in a set of similarity scores; and
organizing, by the computing system, the media items into separate clusters based on the set of similarity scores.

2. The method of claim 1, wherein organizing the media items into separate clusters comprises creating a dendrogram data structure using a hierarchical agglomerative clustering (HAC) algorithm.

3. The method of claim 2, wherein organizing the media items into the separate clusters comprises dividing the created dendrogram data structure into subtrees using a flat clustering algorithm.

4. The method of claim 1, further comprising:
calculating a prominence score of each of the media items; and
creating a hierarchical tree of the media items in each separate cluster by:
selecting as a parent media item of the cluster, the media item of the cluster having a highest prominence score, and
sub-clustering media items other than the parent media item of the cluster based on the similarity score between each two media items of the media items other than the parent media item.

5. The method of claim 4, further comprising modifying the hierarchical tree using a tree fan-out algorithm to achieve a target visual density.

6. The method of claim 4, further comprising generating a cross-edge between a pair of the media items in separate hierarchical trees by:
identifying, for a media item, a number of media items that are most similar to the media item based on the similarity score but are not in the same cluster as the media item.

7. The method of claim 6, further comprising positioning the separate clusters relative to each other using a force layout.

8. The method of claim 7, further comprising positioning the media items within each of the clusters within a Voronoi cell.

9. The method of claim 1, further comprising:
receiving additional or altered metadata from the user; and
re-creating the tags, re-calculating the set of similarity scores, and re-organizing the media items into the separate clusters, using the metadata retrieved from the plurality of metadata providers and the additional or altered metadata received from the user.

10. The method of claim 1, further comprising:
receiving additional or altered metadata from other users based on their respective media library; and
re-creating the tags, re-calculating the set of similarity scores, and re-organizing the media items into the separate clusters, using the metadata retrieved from the plurality of metadata providers and the additional or altered metadata received from the other users.

11. The method of claim 1, wherein calculating the set of similarity scores comprises, for each two of the media items:
weighting, for each media type, the similarity contributions by a pre-defined factor value of the metadata type;
summing the weighted similarity contributions;
summing the pre-defined factor values; and
dividing the sum of the weighted similarity contributions by the sum of the pre-defined factor values.

12. A system comprising:
a metadata module configured to retrieve, by a computing system, over a network from a plurality of metadata providers, metadata about media items within a media library of a user, the metadata specifying one or more metadata types and one or more values of each of the specified one or more metadata types;
a tag module configured to create, by the computing system, for each specified metadata type having one or more non-numerical values, a set of qualitative multi-valued tags by:
accumulating the one or more non-numerical values; and
calculating a normalized weight for each of the accumulated one or more non-numerical values;
the tag module further configured to create, by the computing system, for each specified metadata type having a single numerical value, a quantitative single-value tag by:
calculating a tag weight based on the single numerical value relative to a predefined maximum numerical value;
a similarity module configured to determine a similarity contribution of each specified metadata type between two of the media items in the media library by:
combining, from each qualitative multi-valued tag of the two media items, the normalized weights of the accumulated one or more non-numerical values within each metadata type, and
determining, from each quantitative single-value tag of the two media items, a difference between the respective tag weights of the quantitative single-value tags;
the similarity module further configured to calculate, by the computing system, a similarity score between each two of the media items from the similarity contribution of each metadata type, resulting in a set of similarity scores; and
a cluster module configured to organize, by the computing system, the media items into separate clusters based on the set of similarity scores.

13. The system of claim 12, wherein the cluster module is configured to organize the media items into separate clusters by creating a dendrogram data structure using a hierarchical agglomerative clustering (HAC) algorithm and dividing the created dendrogram data structure into subtrees using a flat clustering algorithm.

14. The system of claim 12, further comprising a tree module configured to:
calculate a prominence score of each of the media items; and
create a hierarchical tree of the media items in each separate cluster by:
selecting as a parent media item of the cluster, the media item of the cluster having a highest prominence score, and
sub-clustering media items other than the parent media item of the cluster based on the similarity score between each two media items of the media items other than the parent media item.

15. The system of claim 14, further comprising a positioning module configured to generate a cross-edge between a pair of the media items in separate hierarchical trees by:
identifying, for a media item, a number of media items that are most similar to the media item based on the similarity score but are not in the same cluster as the media item.

16. The system of claim 15, wherein the positioning module is further configured to position the separate clusters relative to each other using a force layout.

17. The system of claim 16, wherein the positioning module is further configured to position the media items within each of the clusters within a Voronoi cell.

18. The system of claim 12, wherein the metadata module is further configured to:
receive additional or altered metadata from the user; and
re-create the tags, re-calculate the set of similarity scores, and re-organize the media items into the separate clusters, using the metadata retrieved from the plurality of metadata providers and the additional or altered metadata received from the user.

19. The system of claim 12, wherein the metadata module is further configured to:
receive additional or altered metadata from other users based on their respective media library; and
re-create the tags, re-calculate the set of similarity scores, and re-organize the media items into the separate clusters, using the metadata retrieved from the plurality of metadata providers and the additional or altered metadata received from the other users.

20. A non-transitory machine-readable medium having instructions embodied thereon, the instructions executable by one or more processors to perform operations comprising:
retrieving, by a computing system, over a network from a plurality of metadata providers, metadata about media items within a media library of a user, the metadata specifying one or more metadata types and one or more values of each of the specified one or more metadata types;
creating, by the computing system, for each specified metadata type having one or more non-numerical values, a set of qualitative multi-valued tags by:
accumulating the one or more non-numerical values; and
calculating a normalized weight for each of the accumulated one or more non-numerical values;
creating, by the computing system, for each specified metadata type having a single numerical value, a quantitative single-value tag by:
calculating a tag weight based on the single numerical value relative to a predefined maximum numerical value;
determining a similarity contribution of each specified metadata type between two of the media items in the media library by:
combining, from each qualitative multi-valued tag of the two media items, the normalized weights of the accumulated one or more non-numerical values within each metadata type, and
determining, from each quantitative single-value tag of the two media items, a difference between the respective tag weights of the quantitative single-value tags;
calculating, by the computing system, a similarity score between each two of the media items from the similarity contribution of each metadata type, resulting in a set of similarity scores; and
organizing, by the computing system, the media items into separate clusters based on the set of similarity scores.
